(19) United States
(12) Patent Application Publication
(10) Pub. No.: US 2011/0238936 A1
(43) Pub. Date: Sep. 29, 2011

(54) METHOD AND SYSTEM FOR EFFICIENT SNAPSHOTTING OF DATA-OBJECTS

(76) Inventor: Mark G. Hayden, Gardnerville, NV (US)

(21) Appl. No.: 12/749,473

(22) Filed: Mar. 29, 2010

(51) Int. Cl. G06F 12/16; G06F 12/00

(52) U.S. Cl. 711/162; 711/E12.001; 711/E12.103

(57) ABSTRACT

One embodiment of the present invention is directed to a multi-node data-storage system, including a number of component-data-storage-system nodes, which stores data objects, each data object stored as a mirrored portion and an additional portion and a snapshot-operation-triggering mechanism that invokes a snapshot operation on a data object in which mirrored data stored in the mirrored portion of the data object is transformed into data stored in non-mirroring redundant data storage associated with a next snapshot level within the additional portion of the data object. An additional embodiment of the present invention is directed to a multi-node data-storage system in which a snapshot-operation-triggering mechanism automatically invokes a snapshot operation on a data object.

### TECHNICAL FIELD

The present invention is related to data-storage systems and, in particular, to multi-node data-storage systems that efficiently store data objects as mirrored portions and additional portions.

### BACKGROUND

In early computer systems, data was stored by individual users on magnetic tapes, punch cards, and early mass-storage devices, with computer users bearing entire responsibility for data availability, data management, and data security. The development of operating systems resulted in development of file systems with operating-system-provided interfaces and additional operating-system-provided utilities, including automated backup, mirroring, and other such utilities. With the development of high-bandwidth and inexpensive electronic communications, rapidly increasing computational bandwidths of computer systems, and relentless increase in price-performance of computer systems, an enormous variety of single-computer and distributed data-storage systems are available that span a wide range of functionality, capacity, and cost.

When data that is stored by a data-storage system has more than immediate, ephemeral utility, and even for certain types of short-lived data, users seek to store data in data-storage systems in a fault-tolerant manner. Modern data-storage systems provide for redundant storage of data, using methods that include data-object mirroring and parity encoding. In the event that a mass-storage device, computer-system node of a multi-node data-storage system, electronic communications medium or system, or other component of a data-storage system fails, any data lost as a result of the failure can be recovered automatically, without intervention by the user, in many modern data-storage systems that redundantly store data. Each of the various different methods for redundantly storing data is associated with different advantages and disadvantages. Developers of data-storage systems, vendors of data-storage systems, and, ultimately, users of data-storage systems and computer systems that access data stored in data-storage systems continue to seek improved data-storage systems that provide automated, redundant data storage and data recovery with maximum efficiency and minimum cost.

### BRIEF DESCRIPTION OF THE DRAWINGS

FIG. 1 shows a high level diagram of a multi-node data-storage system.

FIG. 2 illustrates a typical electronic computer that may serve as a component data-storage system within a multi-node data-storage system.

FIGS. 3-4 illustrate data mirroring.

FIG. 5 shows a high-level diagram depicting erasure-coding-based data redundancy.

FIG. 6 shows an exemplary 3+1 erasure-coding redundancy scheme using the same illustration conventions as used in FIGS. 3 and 4.

FIGS. 7A-F illustrate a snapshot-based method by which data objects are stored in multi-node data-storage systems that represent embodiments of the present invention.

FIG. 8 provides a control-flow diagram of a routine “monitor data objects” that represents an automated snapshot-triggering mechanism within a multi-node data-storage system that represents one embodiment of the present invention.

FIG. 9 shows an alternative version of the routine “monitor data objects” that represents a different embodiment of the present invention.

### DETAILED DESCRIPTION

Embodiments of the present invention are directed to multi-node data-storage systems that redundantly store data objects, on behalf of users, to prevent data loss due to node or component failure. In certain embodiments of the present invention, a given data object may be initially stored using mirror redundancy, but, over time, portions of the data within the data object may migrate to parity-encoded data-storage or other types of redundant data storage by means of data-object-snapshot operations. Certain embodiments of the present invention monitor data objects within a multi-node data-object system in order to automatically trigger data-object snap-shot operations in order to optimize use of data-storage capacity, minimize computational and time overheads associated with redundant storage of data objects, and, in certain embodiments of the present invention, in order to optimize additional characteristics of the multi-node data-storage system with respect to redundant storage of data objects.

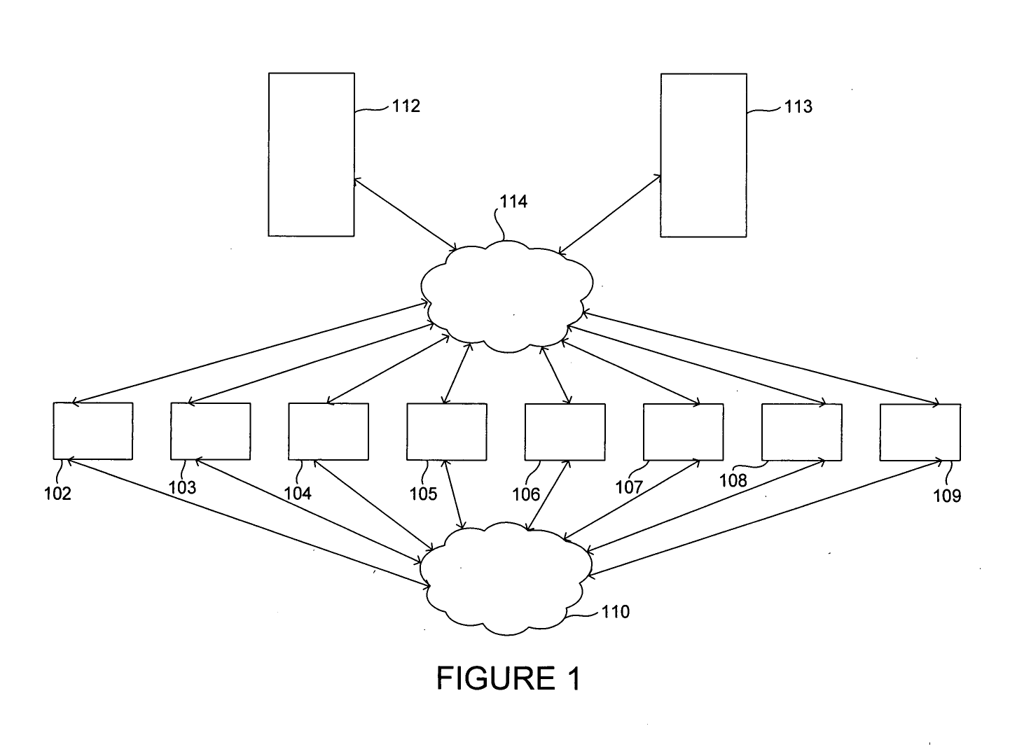

FIG. 1 shows a high level diagram of a multi-node data-storage system. A multi-node data-storage system comprises a number of small, discrete component data-storage systems 102-109, such as server computers, that intercommunicate with one another through a first communications medium 110, such as a storage-area network (“SAN”) or local-area network (“LAN”), and that can receive data-storage requests and data-access requests from, and transmit responses to received data-storage requests and data-access requests to, a number of remote host computers 112-113 through a second communications medium 114, such as a local-area network (“LAN”). The first and second communications media may be a single communications medium, in certain multi-node data-storage systems, or may be two or more discrete communications media, in other multi-node data-storage systems. Each component-data-storage system 102-109 generally includes an interface through which requests can be received and responses can be transmitted to the remote host computers. In asymmetrical multi-node data-storage systems, one or a small number of the component-data-storage systems may serve as portals to the multi-node data-storage system, and may distribute requests received from remote host computers among the component-data-storage systems and forward responses from component-data-storage systems to the remote host computer systems. In symmetrical multi-node data-storage systems, each of the component-data-storage systems may receive requests from, and transmit responses to, remote host computer systems, and the component-data-storage systems in such symmetrical multi-node data-storage systems cooperate to distribute requests and data-storage among themselves. Embodiments of the present invention are applicable to both symmetrical and asymmetrical multi-node data-storage systems, as well as to other types of multi-node data-storage systems.

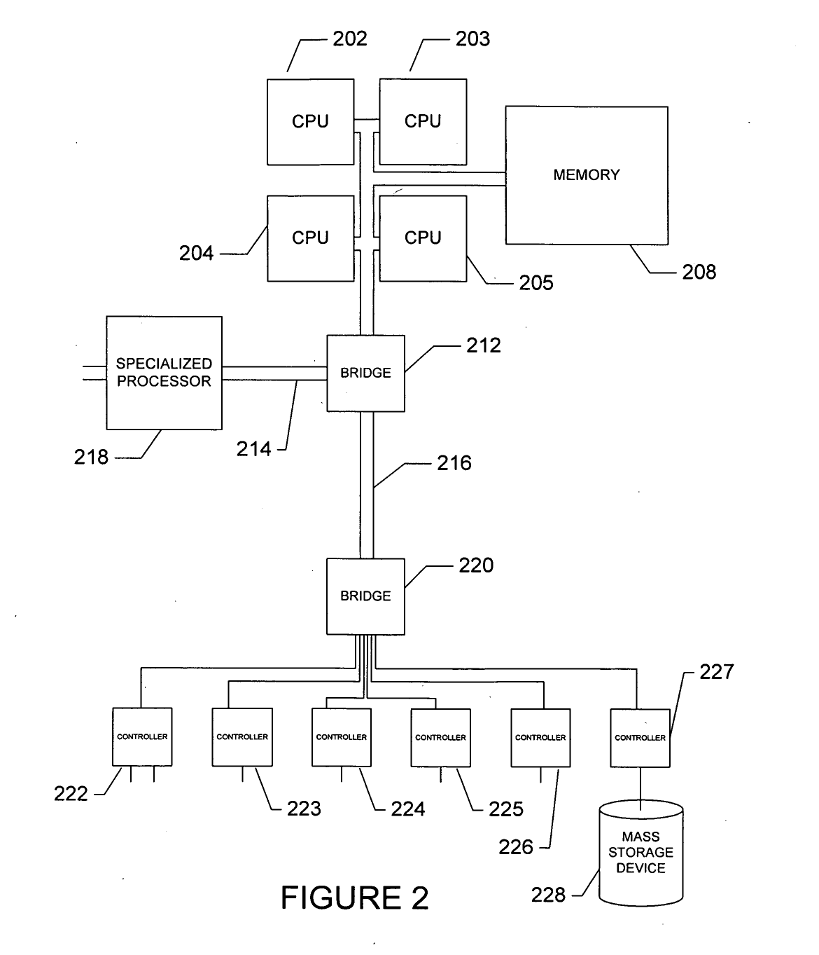

FIG. 2 illustrates a typical electronic computer that may serve as a component data-storage system within a multi-node data-storage system. The computer system contains one or multiple central processing units (“CPUs”) 202-205, one or more electronic memories 208 interconnected with the CPUs by a CPU/memory-subsystem bus 210 or multiple busses, a first bridge 212 that interconnects the CPU/memory-subsystem bus 210 with additional busses 214 and 216 or other types of high-speed interconnection media, including multiple, high-speed serial interconnects. These busses or serial interconnections, in turn, connect the CPUs and memory with specialized processors, such as a graphics processor 218, and with one or more additional bridges 220, which are interconnected with high-speed serial links or with multiple controllers 222-227, such as controller 227, that provide access to various different types of mass-storage devices 228, electronic displays, input devices, communications transceivers, and other such components, subcomponents, and computational resources. Component data-storage system may include many additional internal components, including additional memories and memory levels, additional busses, serial interconnects, and other internal communications media, additional processors and controllers, power supplies, cooling systems, and additional components.

Data-storage systems, including multi-node data-storage system systems, provide not only data-storage facilities, but also provide and manage automated redundant data storage, so that, when portions of stored data are lost, due to a node failure, disk-drive failure, failure of particular cylinders, tracks, sectors, or blocks on disk drives, failures of other electronic components, failures of communications media, and other failures, the lost data can be recovered from redundant data stored and managed by the data-storage systems, generally without intervention by host computers, system administrators, or users.

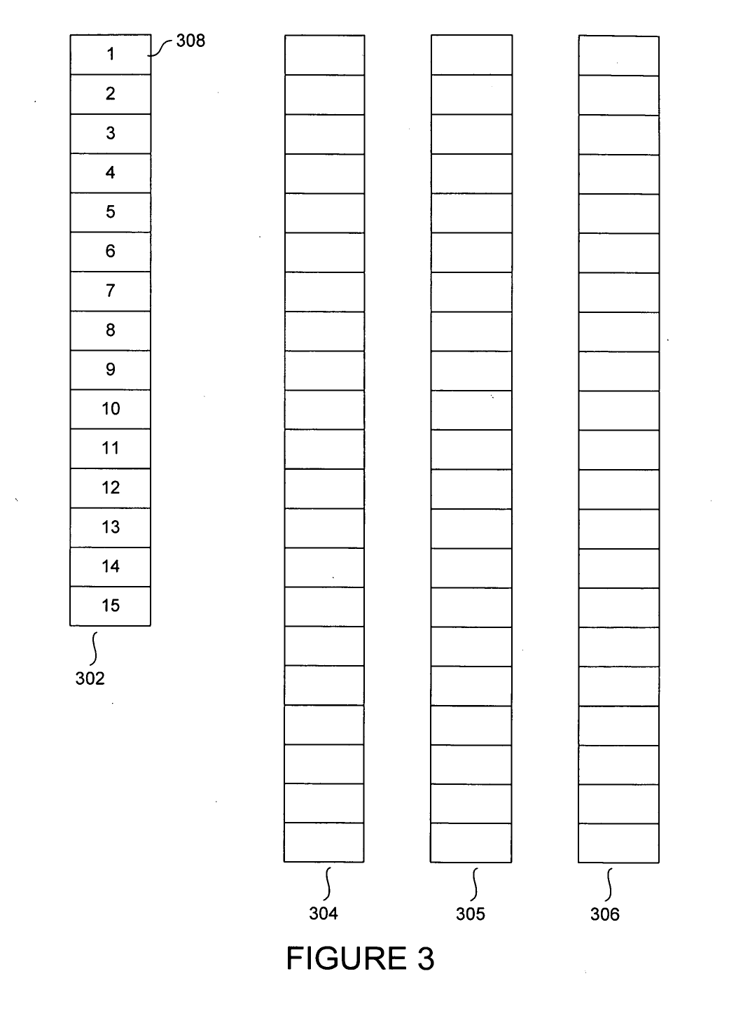

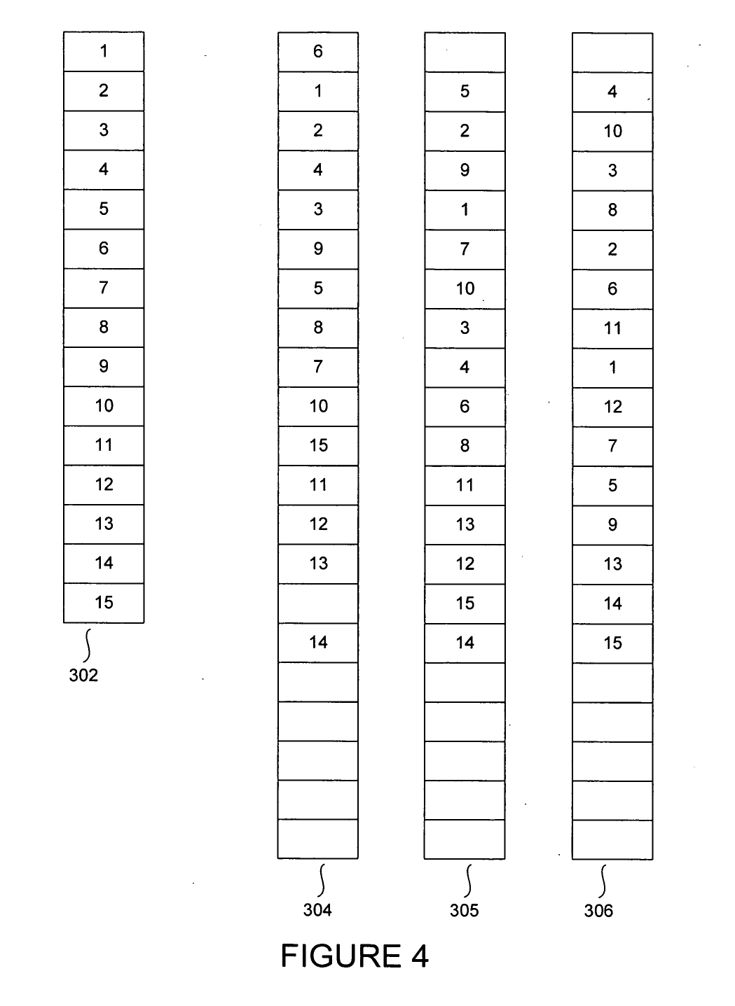

The multi-node data-storage systems that serve as a context for describing embodiments of the present invention automatically support at least two different types of data redundancy. The first type of data redundancy is referred to as “mirroring,” which describes a process in which multiple copies of data objects are stored on two or more different nodes, so that failure of one node does not lead to unrecoverable data loss. FIGS. 3-4 illustrate the concept of data mirroring. FIG. 3 shows a data object 302 and a logical representation of a portion of the data contents of three nodes 304-306 according to an embodiment of the present invention. The data object 302 comprises 15 sequential data units, such as data unit 308, numbered “1” through “15” in FIG. 3. A data object may be a volume, a file, a data base, or another type of data object, and data units may be blocks, pages, or other such groups of consecutively-addressed physical storage locations. FIG. 4 shows triple-mirroring redundant storage of the data object 302 on the three nodes 304-306. Each of the three nodes contains copies of all 15 of the data units within the data object 302.

In many illustrations of mirroring; the layout of the data units is shown to be identical in all mirror copies of the data object. However, in reality, a node may choose to store data units anywhere on its internal data-storage components, including disk drives. Embodiments of the present invention are generally directed to storage of data objects within a multi-node data-storage system at the node level, rather than concerned with the details of data storage within nodes. As well understood by those familiar with data-storage systems, a data-storage system generally includes many hierarchical levels of logical data-storage levels, with the data and data locations described by logical addresses and data-unit lengths at each level. For example, an operating system may provide a file system, in which files are the basic data object, with file addresses comprising path names that locate files within a hierarchical directory structure. However, at a lower level, the files are stored on particular mass-storage devices and/or in particular memories, which may store blocks of data at particular logical block locations. The controller within a mass-storage device translates logical block addresses to physical, data-storage-media addresses, which may involve identifying particular cylinders and sectors within multi-platter disks, although, when data described by such physical addresses is accessed, various additional levels of redirection may transpire before the actual physical location of the data within one or more disk platters is identified and accessed. For purposes of describing the present invention, data objects are stored as a set of one or more data pages within nodes of a multi-node data-storage system, which employs methods to ensure that the data is stored redundantly by two or more nodes to ensure that failure of a node does not result in data loss. The present invention is equally applicable to redundant storage of data within certain single-computer systems or nodes, or across multiple data-storage systems that together comprise a geographically distributed data-storage system.

In FIG. 4, the copies of the data units, or data pages, within the data object 302 are shown in different orders and positions within the three different nodes. Because each of the three nodes 304-306 stores a complete copy of the data object, the data object is recoverable even when two of the three nodes fail. The probability of failure of a single node is generally relatively slight, and the combined probability of failure of all three nodes of a three-node mirror is generally extremely small. A multi-node data-storage system may store millions, billions, trillions, or more different data objects, and each different data object may be separately mirrored over a different number of nodes within the data-storage system. For example, one data object may be mirrored over nodes 1, 7, 8 while another data object may be mirrored over nodes 2, 3, and 4.

A second type of redundancy is referred to as “erasure coding” redundancy or “parity encoding.” Erasure-coding redundancy is somewhat more complicated than mirror redundancy. Erasure-coding redundancy often employs Reed-Solomon encoding techniques used for error-control coding of communications messages and other digital data transferred through noisy channels. These error-control-coding techniques use binary linear codes.

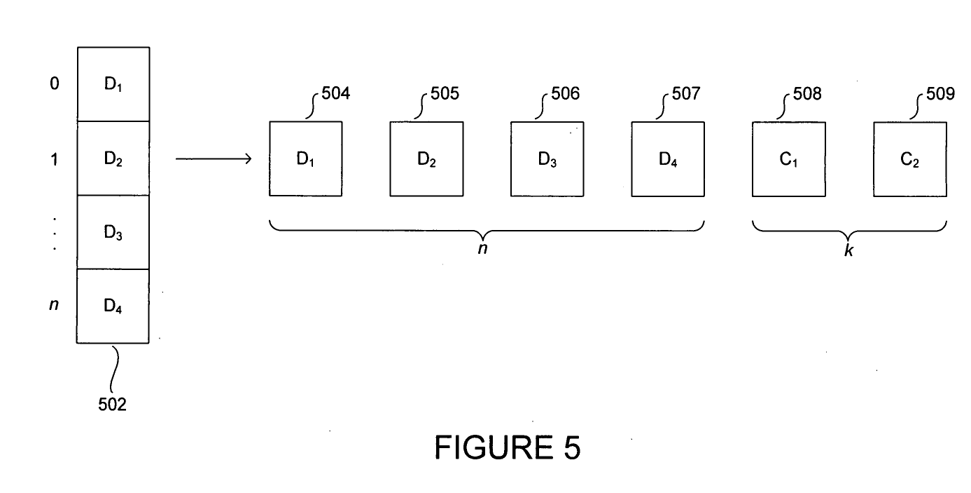

FIG. 5 shows a high-level diagram depicting erasure-coding-based data redundancy. In FIG. 5, a data object 502 comprising n=4 data units is distributed across six different nodes 504-509. The first n nodes 504-506 each stores one of the n data units. The final k=2 nodes 508-509 store checksum, or parity, data computed from the data object. The erasure coding redundancy scheme shown in FIG. 5 is an example of an n+k erasure-coding redundancy scheme. Because n=4 and k=2, the specific n+k erasure-coding redundancy scheme is referred to as a “4+2” redundancy scheme. Many other erasure-coding redundancy schemes are possible, including 8+2, 3+3, 3+1, and other schemes. As long as k or less of the n+k nodes fail, regardless of whether the failed nodes contain data or parity values, the entire data object can be restored. For example, in the erasure coding scheme shown in FIG. 5, the data object 502 can be entirely recovered despite failures of any pair of nodes, such as nodes 505 and 508.

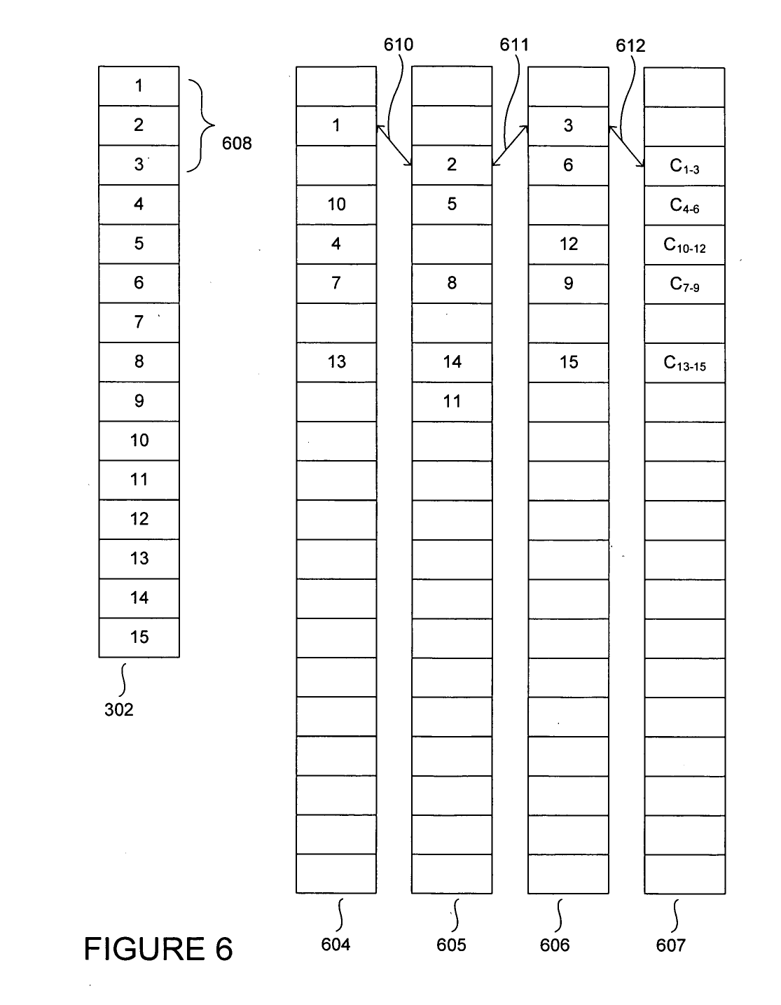

FIG. 6 shows an exemplary 3+1 erasure-coding redundancy scheme using the same illustration conventions as used in FIGS. 3 and 4. In FIG. 6, the 15-data-unit data object 302 is distributed across four nodes 604-607. The data units are striped across the four disks, with each three-data-unit subset of the data object sequentially distributed across nodes 604-606, and a check sum, or parity, data unit for the stripe placed on node 607. The first stripe, consisting of the three data units 608, is indicated in FIG. 6 by arrows 610-612. Although, in FIG. 6, checksum data units are all located on a single node 607, the stripes may be differently aligned with respect to the nodes, with each node containing some portion of the checksum or parity data units.

Erasure-coding redundancy is obtained by mathematically computing checksum or parity bits for successive sets of n bytes, words, or other data units, by methods conveniently expressed as matrix multiplications. As a result, k data units of parity or checksum bits are computed from n data units. Each data unit typically includes a number of bits equal to a power of two, such as 8, 16, 32, or a higher power of two. Thus, in an 8+2 erasure coding redundancy scheme, from eight data units, two data units of checksum, or parity bits, are generated, all of which can be included in a ten-data-unit stripe. In the following discussion, the term “word” refers to a granularity at which encoding occurs, and may vary from bits to longwords or data units of greater length.

The i^{th} checksum word cᵢ may be computed as a function of all n data words by a function Fᵢ(d₁, d₂, . . . , dₙ) which is a linear combination of each of the data words dⱼ multiplied by a coefficient f_{i,j}, as follows:

$${c}_{i} = {F}_{i} ( {d}_{1} , {d}_{2} , … , {d}_{n} ) = {\sum }_{j = 1}^{n} {d}_{j} , {f}_{i , j}$$

In matrix notation, the equation becomes:

$$[ \begin{matrix}{c}_{1} \\ {c}_{2} \\ ⋮ \\ {c}_{k}\end{matrix} ] = [ \begin{matrix}{f}_{1 , 1} & {f}_{1 , 2} & … & {f}_{1 , n} \\ {f}_{2 , 1} & {f}_{2 , 2} & … & {f}_{2 , n} \\ ⋮ & ⋮ & & ⋮ \\ {f}_{k , 1} & {f}_{k , 2} & … & {f}_{k , n}\end{matrix} ] [ \begin{matrix}{d}_{1} \\ {d}_{2} \\ ⋮ \\ {d}_{n}\end{matrix} ]$$

or:

C=FD

In the Reed-Solomon technique, the function F can be chosen to be a k×n Vandennonde matrix with elements fᵢⱼ equal to j^{i-l}, or:

$$F = [ \begin{matrix}1 & 1 & … & 1 \\ 1 & 2 & … & n \\ ⋮ & ⋮ & & ⋮ \\ 1 & {2}^{k - 1} & … & {n}^{k - 1}\end{matrix} ]$$

If a particular word dᵢ is modified to have a new value d′ᵢ, then a new i^{th} check sum word c′ᵢ can be computed as:

c′ᵢ=cᵢ+f_{i,j}(d′ⱼ−d^{J})

or:

c′=C+FD′−FD=C+F(D′−D)

Thus, new checksum words are easily computed from the previous checksum words and a single column of the matrix F.

Lost words from a stripe are recovered by matrix inversion. A matrix A and a column vector E are constructed, as follows:

$$A = [ \frac{1}{F} ] = [ \begin{matrix}1 & 0 & 0 & … & 0 \\ 0 & 1 & 0 & … & 0 \\ 0 & 0 & 1 & … & 0 \\ ⋮ & ⋮ & ⋮ & & ⋮ \\ 1 & 1 & 1 & … & 1 \\ 1 & 2 & 3 & … & n \\ ⋮ & ⋮ & ⋮ & & ⋮ \\ 1 & {2}^{k - 1} & {3}^{k - 1} & … & {n}^{k - 1}\end{matrix} ]$$

$$E = [ \frac{D}{C} ] = [ \begin{matrix}{d}_{1} \\ {d}_{2} \\ ⋮ \\ {d}_{n} \\ {c}_{1} \\ {c}_{2} \\ ⋮ \\ {c}^{k}\end{matrix} ] ,$$

It is readily seen that:

AD=E

or:

$$[ \begin{matrix}1 & 0 & 0 & … & 0 \\ 0 & 1 & 0 & … & 0 \\ 0 & 0 & 1 & … & 0 \\ ⋮ & ⋮ & ⋮ & & ⋮ \\ 1 & 1 & 1 & … & 1 \\ 1 & 2 & 3 & … & n \\ ⋮ & ⋮ & ⋮ & & ⋮ \\ 1 & {2}^{k - 1} & {3}^{k - 1} & … & {n}^{k - 1}\end{matrix} ] [ \begin{matrix}{d}_{1} \\ {d}_{2} \\ ⋮ \\ {d}_{n}\end{matrix} ] = [ \begin{matrix}{d}_{1} \\ \begin{matrix}{d}_{2} \\ {d}_{3}\end{matrix} \\ ⋮ \\ {d}_{n} \\ {c}_{1} \\ {c}_{2} \\ ⋮ \\ {c}^{k}\end{matrix} ] .$$

One can remove any k rows of the matrix A and corresponding rows of the vector E in order to produce modified matrices A′ and E′, where A′ a square matrix. Then, the vector D representing the original data words can be recovered by matrix inversion as follows:

A′D=E′

D=A^{t-1}E′

Thus, when k or fewer data or checksum words are erased, or lost, k data or checksum words including the k or fewer lost data or checksum words can be removed from the vector E, and corresponding rows removed from the matrix A, and the original data or checksum words can be recovered by matrix inversion, as shown above.

While matrix inversion is readily carried out for real numbers using familiar real-number arithmetic operations of addition, subtraction, multiplication, and division, discrete-valued matrix and column elements used for digital error control encoding are suitable for matrix multiplication only when the discrete values form an arithmetic field that is closed under the corresponding discrete arithmetic operations. In general, checksum bits are computed for words of length w:

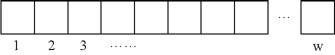

A w-bit word can have any of 2^{w} different values. A mathematical field known as a Galois field can be constructed to have 2^{w} elements. The arithmetic operations for elements of the Galois field are, conveniently:

a±b=a⊕b

a*b=anti log [log(a)+log(b)]

a÷b=anti log [log(a)−log(b)]

where tables of logs and antilogs for the Galois field elements can be computed using a propagation method involving a primitive polynomial of degree w.

Mirror-redundancy schemes are conceptually simpler, and easily lend themselves to various reconfiguration operations. For example, if one node of a 3-node, triple-mirror-redundancy scheme fails, the remaining two nodes can be reconfigured as a 2-node mirror pair under a double-mirroring-redundancy scheme. Alternatively, a new node can be selected for replacing the failed node, and data copied from one of the surviving nodes to the new node to restore the 3-node, triple-mirror-redundancy scheme. By contrast, reconfiguration of erasure coding redundancy schemes is not as straightforward. For example, each checksum word within a stripe depends on all data words of the stripe. If it is desired to transform a 4+2 erasure-coding-redundancy scheme to an 8+2 erasure-coding-redundancy scheme, then all of the checksum bits may be recomputed, and the data may be redistributed over the 10 nodes used for the new, 8+2 scheme, rather than copying the relevant contents of the 6 nodes of the 4+2 scheme to new locations. Moreover, even a change of stripe size for the same erasure coding scheme may involve recomputing all of the checksum data units and redistributing the data across new node locations. In most cases, change to an erasure-coding scheme involves a complete construction of a new configuration based on data retrieved from the old configuration rather than, in the case of mirroring-redundancy schemes, deleting one of multiple nodes or adding a node, with copying of data from an original node to the new node. Mirroring is generally significantly less efficient in space than erasure coding, but is more efficient in time and expenditure of processing cycles. For example, in the case of a one-block WRITE operation carried out on already stored data, a mirroring redundancy scheme involves execution of a one-block WRITE to each node in a mirror, while a parity-encoded redundancy scheme may involve reading the entire stripe containing the block to be written from multiple nodes, recomputing the checksum for the stripe following the WRITE to the one block within the stripe, and writing the new block and new checksum back to the nodes across which the stripe is distributed.

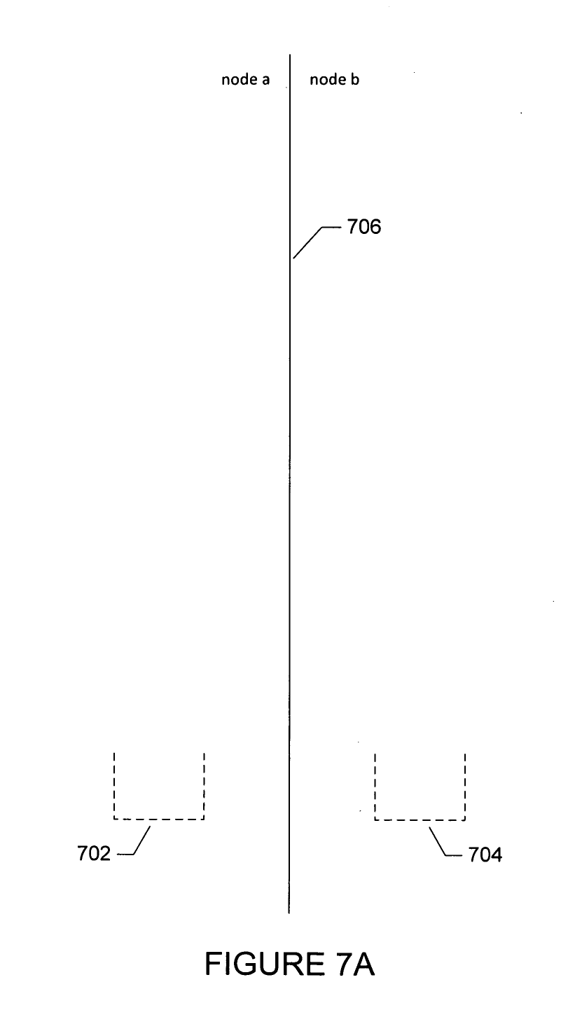

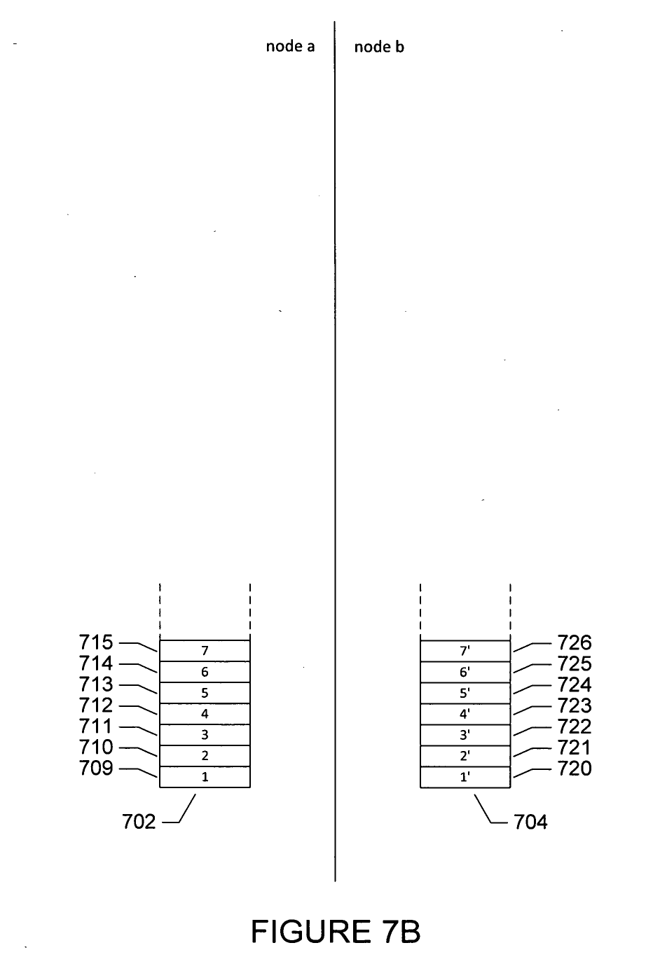

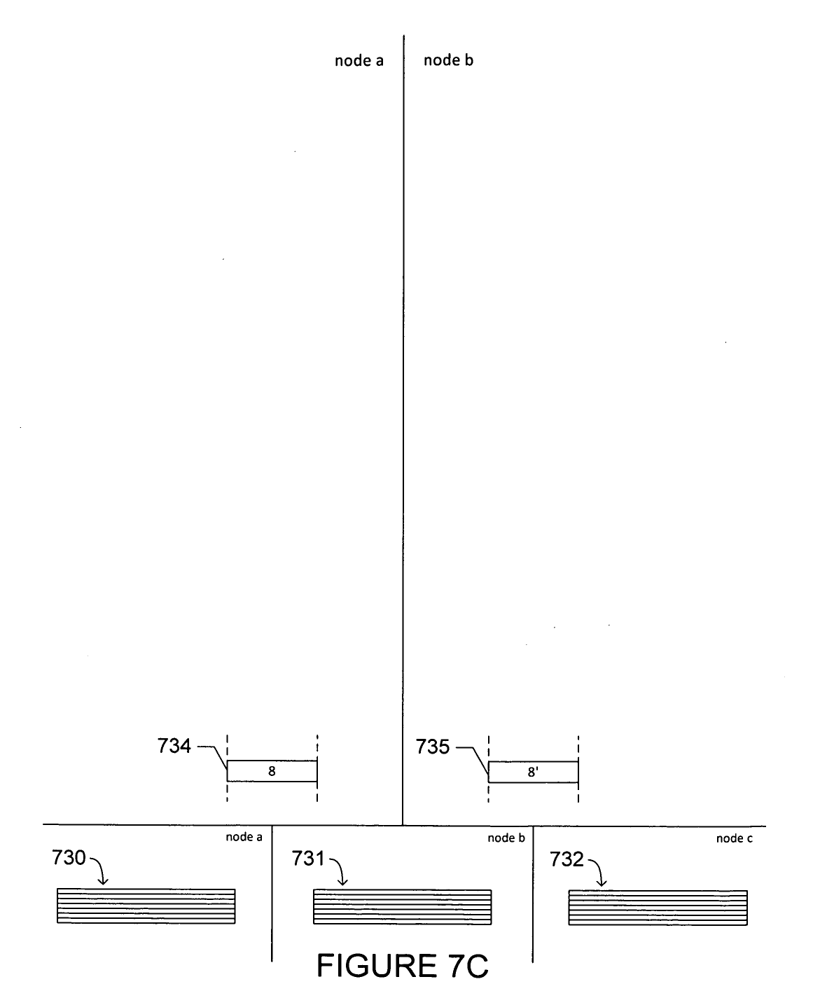

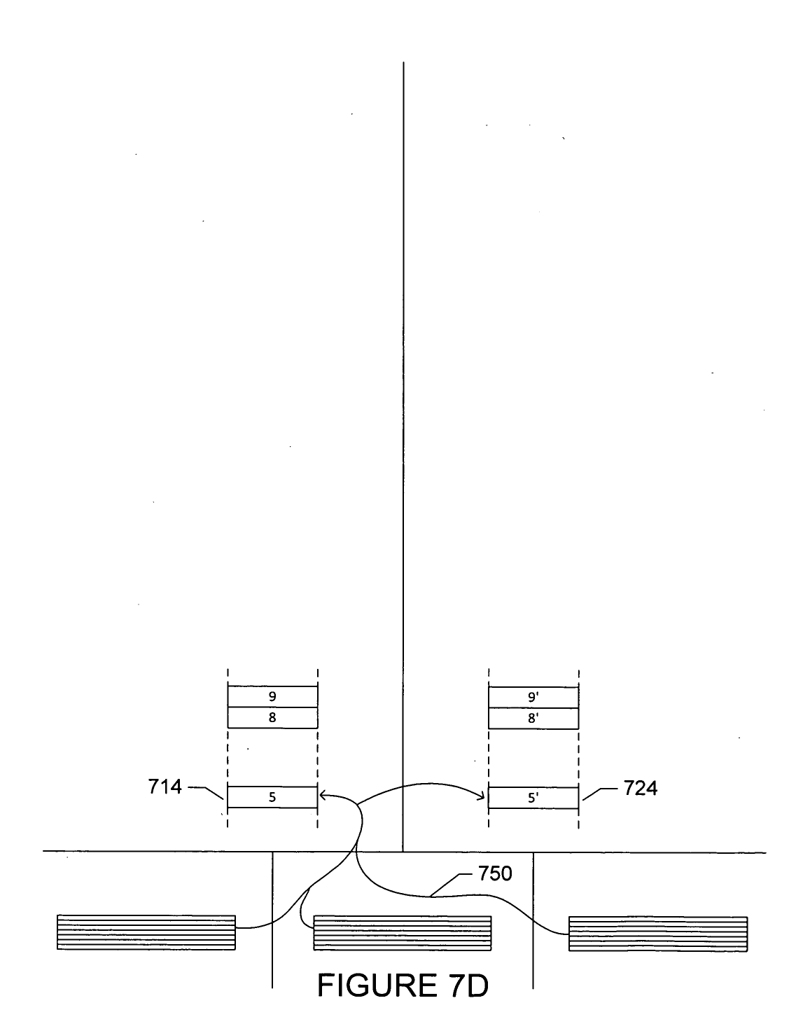

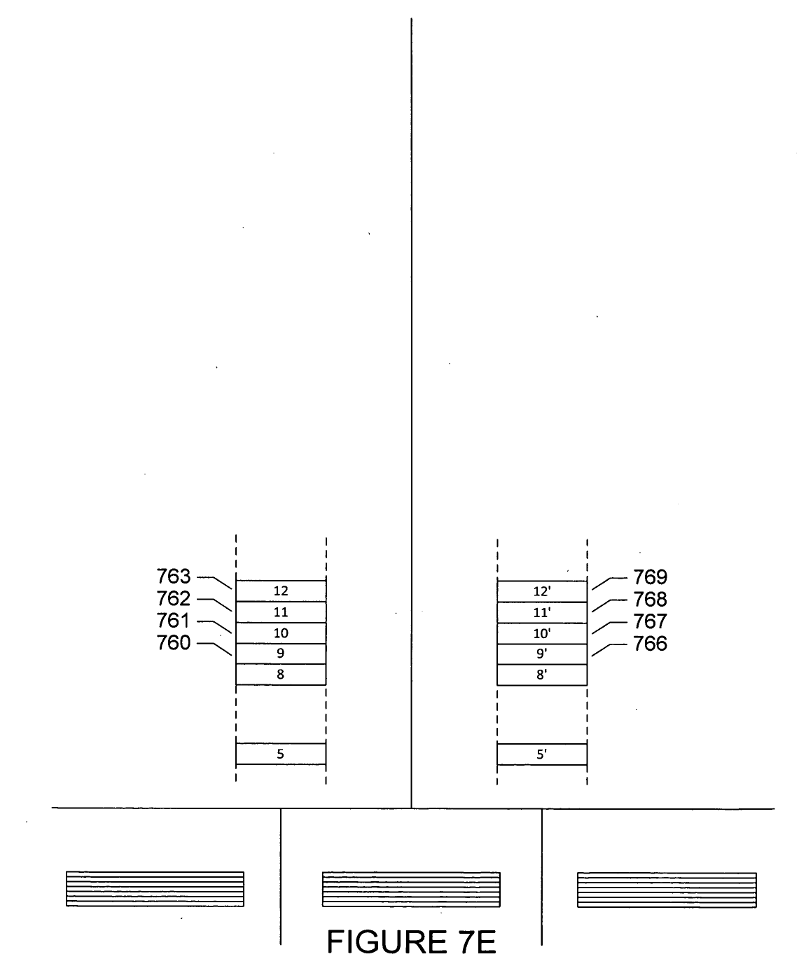

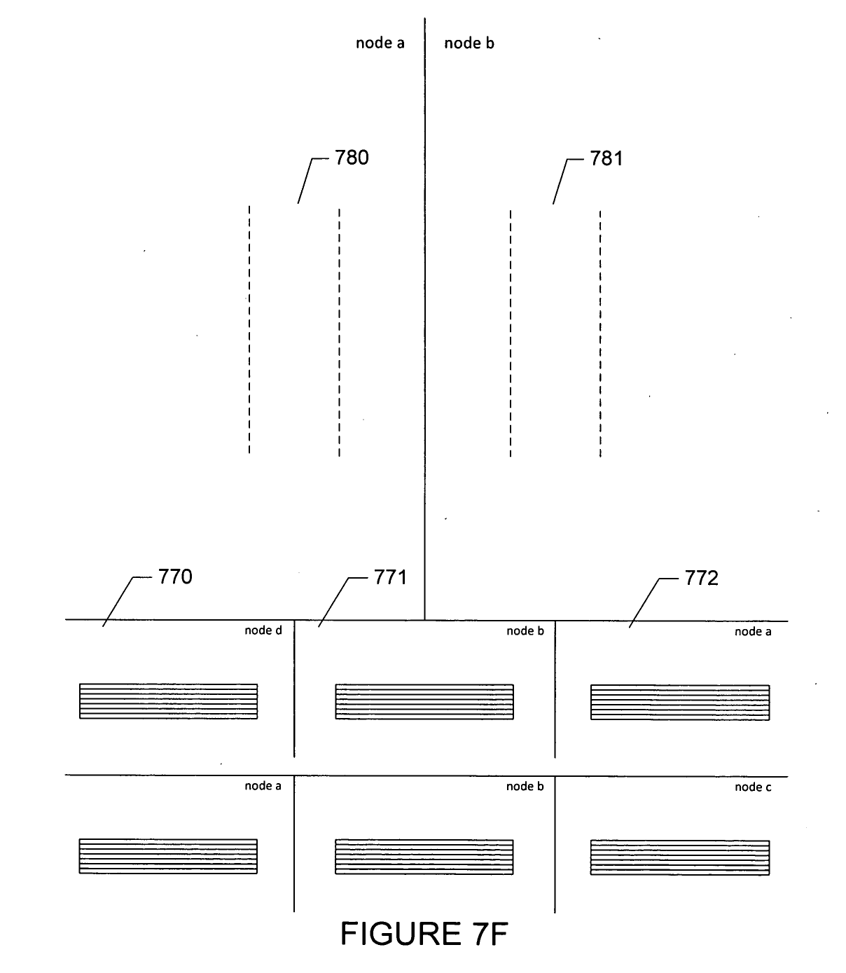

FIGS. 7A-F illustrate a snapshot-based method by which data objects are stored in multi-node data-storage systems that represent embodiments of the present invention. Initially, a data object is stored as multiple copies using mirror redundancy. FIG. 7A illustrates a data object, following creation, in which a mirror pair 702 and 704 of copies of the data object is created on nodes a and b of a multi-node distributed data-storage system. In FIG. 7A, and in subsequent FIGS. 7B-F, the vertical line 706 in the center of the figure represents a boundary between nodes a and b. Thus, the nascent data object is stored in duplicate, with a first copy 702 residing within node a and a second copy 704 residing within node b. A mirror pair is maintained synchronously, so that any updates to a first copy are forwarded to, and carried out on, all other copies of the mirror. In distributed systems, techniques may be used to ensure that no WRITE operation is committed to any member of the mirror unless the WRITE operation is guaranteed to be subsequently or concurrently carried out on all other members.

As shown in FIG. 7B, following creation of the data object, host computers may direct WRITE operations to the nascent data objects to store data units within the data objects. In FIG. 7B, for example, the data object contains seven data units, data units 710-715 in the first copy 702 on node a and data units 720-726 in the second copy 704 on node b. As discussed above, mirroring of data objects is expensive in data-storage capacity, since two or more complete copies of each data unit of the data object are stored. However, mirroring is easily implemented, can be flexibly redistributed among nodes of a multi-node data-storage system, and provides rapid write access to data units within the data object. In many cases, particularly in archiving data-storage systems, writing of data objects occurs most frequently within a small subset of the most recently written and/or created data units within a data object. Much of the earlier-written and/or earlier-created data units within a data object tend to be only infrequently accessed, after a period of time, and even less frequently accessed for WRITE operations. This being the case, embodiments of the present invention employ a snapshot operation by which mirrored data associated with a data object can be transformed to parity-encoded data, with subsequently created data or data subsequently accessed for WRITE operations stored separately by mirror redundancy. Thus, for example, a first snapshot operation carried out on the data object shown in FIG. 7B generates a partially mirrored, partially parity-encoded data object, as shown in FIG. 7C. The original seven data units stored by mirror redundancy within the data object, shown in FIG. 7B, are moved, by the snapshot operation, into parity-encoded data storage 730-732 in FIG. 7C, in which the parity-encoded data units are striped across three nodes, while a data unit 734-735 written to the data object following the snapshot operation is stored by mirror redundancy in a mirrored portion of the data object.

In FIG. 7C, the parity-encoded portion of the data object is shown distributed among three nodes, while the mirrored portion of the data object is shown distributed among two nodes. In fact, the mirrored portion of the data object may be mirrored across any two or more nodes, depending on various considerations and administrative decisions, and the parity-encoded portion of a data object corresponding to a particular snapshot level may be distributed across a number of nodes, including the same nodes, overlapping nodes, or different nodes with respect to the nodes across which the mirrored portion of the data object is mirrored. In certain embodiments of the present invention, the mirrored portion of a data object may be collocated with all or a portion of the parity-encoded portion.

As shown in FIG. 7D, following a first snapshot operation, discussed above with reference to FIG. 7C, WRITE access has been made to the fifth data unit which, following the first snapshot operation, resides in the parity-encoded portion of the data object associated with the first snapshot level. In this case, as indicated by curved arrows in FIG. 7D, such as curved arrow 750, the filth data unit is reassembled from the parity-encoded portion of the data object and copied 714 and 724 to the mirrored portion of the data object, prior to carrying out the WRITE operation, in the case that the WRITE operation does not write the entire fifth data unit. Thus, multiple copies of data units may end up stored by the multi-node data-storage system as a result of subsequent write access to data units that have been moved to parity-encoded portions of the data object associated with snapshot levels.

As shown in FIG. 7E, additional write-access operations are carried out that result in additional data units 760-763 and 766-769 being stored within the mirrored portion of the data object. At this point in time, as shown in FIG. 7F, a second snapshot operation may be undertaken, to generate a second level 770-772 of parity-encoded data units within the data object. As with any snapshot operation, a mirrored-portion of the data object 780-781 remains available for subsequent data-unit creation or write access to previously created data units.

In certain multi-node data-storage systems, multiple parity-encoded data sets corresponding to multiple snapshot levels may be merged, at various points in time, and, in certain cases, may be moved to slower and cheaper data-storage components and/or media. For example, in data archiving systems, older parity-encoded data sets associated with snapshot levels that have not been accessed for a long period of time may be transferred from expensive, fast disk drives to cheaper, slower disk drives or to tape-based archives.

In certain multi-node data-storage systems, snapshot operations are carried out for data objects either as a result of a command issued by a data-storage-system user or system administrator or according to snapshot-triggering script programs that trigger snapshot operations at fixed intervals of time, such as on a daily or weekly basis. However, manual and fixed-interval generation of snapshots may result in significantly non-optimal data-storage-capacity usage and significantly non-optimal usage of computational bandwidth within a multi-node data-storage system. Whenever data stored in the mirrored portion of a data object is not accessed for long periods of time, data-storage capacity is non-optimally used, because the data could be more space-efficiently stored using parity-encoding redundancy. By contrast, when data stored via parity-encoding redundancy is accessed for writing, as discussed above, additional READ and WRITE operations generally need to be performed to update the checksum for the stripe containing a data unit that is to be written, and when data stored via parity-encoding redundancy is accessed for reading and when an error in the accessed data is indicated by the checksum, significant computational overhead is generally expended to locate and reconstruct the data prior to carrying out the requested access.

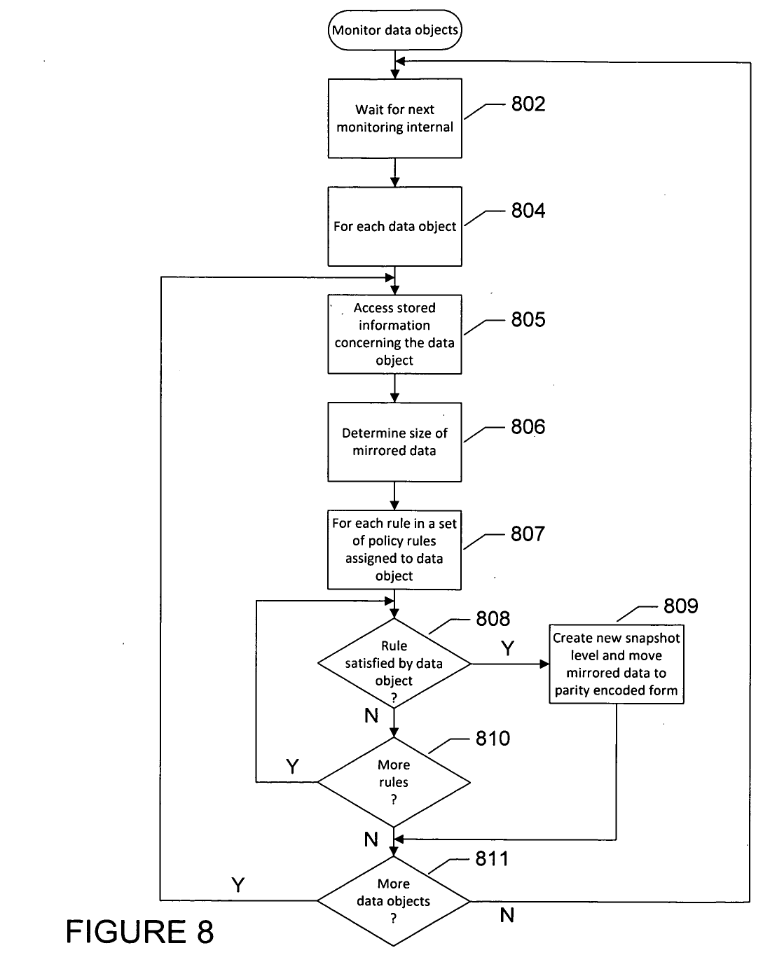

Certain embodiments of the present invention continuously monitor data objects and automatically trigger snapshot operations on data objects based on a variety of different considerations. FIG. 8 provides a control-flow diagram of a routine “monitor data objects” that represents an automated snapshot-triggering mechanism within a multi-node data-storage system that represents one embodiment of the present invention. In step 802, the routine “monitor data objects” waits for a timer expiration associated with a next monitoring interval or another trigger for a next data-object-monitoring iteration. Monitoring intervals may range from seconds to minutes or longer periods of time. At the next monitoring interval, the for-loop of steps 804-811 is executed, in which each data object that is being monitored for automatic snapshot triggering by the multi-node data-storage system is considered. In steps 805-806, the routine “monitor data objects” accesses any information that is stored with regard to the data object, such as number of write accesses, computational bandwidth expended in servicing accesses to the data object, and other such information, as well as the size of the mirrored portion of the data object. Then, in the inner for-loop of steps 807-810, a set of policy rules are considered, each policy rule associated with the data object either automatically or by a system administrator or user. When a rule is satisfied in considering the information associated with the data object obtained in steps 806-807, or, in other words, when a Boolean expression representing the rule, with various variables substituted with information collected in steps 806-807, returns the Boolean value TRUE, then a new snapshot level is generated for the data object, as discussed above with reference to FIGS. 7C and 7F, and currently the mirrored data is transformed to parity-encoded data at a new snapshot level associated with the data object in step 809.

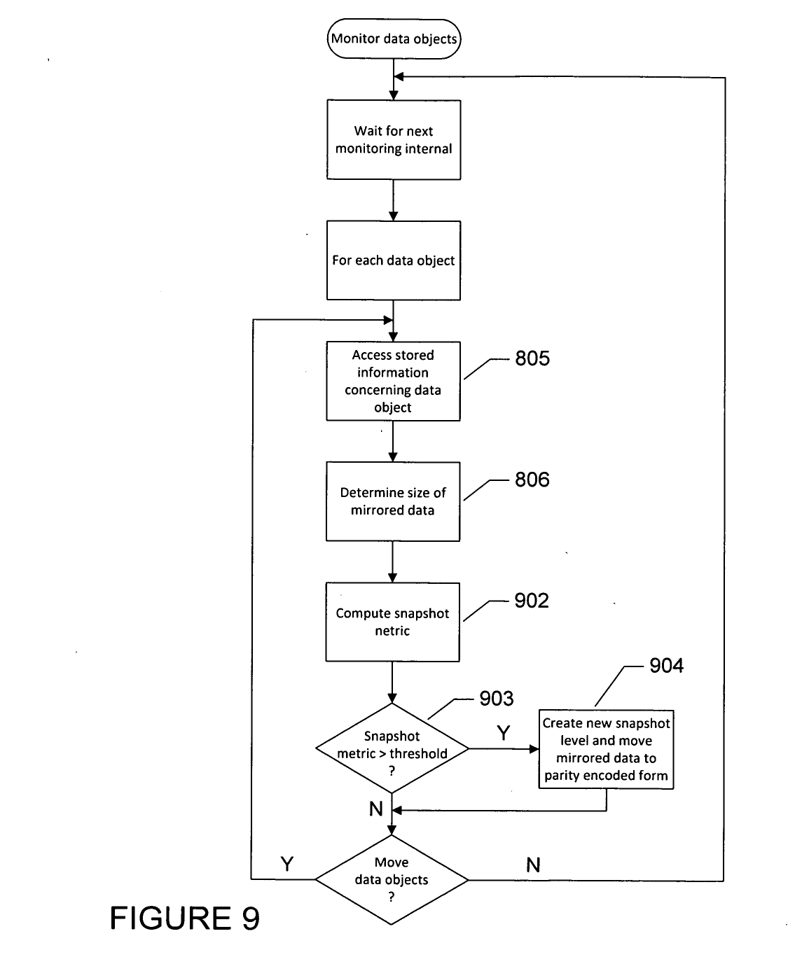

FIG. 9 shows an alternative version of the routine “monitor data objects” that represents a different embodiment of the present invention. Many of the steps in FIG. 9 are identical to corresponding steps in FIG. 8, and are not further discussed. However, in places of steps 807-810, the inner for-loop, of FIG. 8, the alternative version of the routine “monitor data objects” includes steps 902-904, with step 904 equivalent to step 809 in FIG. 8. In step 902, a snapshot metric is computed from the information collected in steps 805 and 806. When the snapshot metric has a numerical value greater than a threshold value, as determined in step 903, then a new snapshot level is created with respect to the data object, in step 809. Thus, rather than evaluating a set of rules, any one of which, when evaluated to TRUE, triggers a snapshot operation, as in the version of the routine “monitor data objects” shown in FIG. 8, the alternative version of the routine “monitor data objects” computes a snapshot metric, by, for example, numerically adding various values associated with considerations corresponding to the rules considered in step 808 of FIG. 8, and triggers a snapshot only when the computed snapshot metric exceeds the threshold value.

The routine “monitor data objects” may be executed in distributed fashion within a multi-node data-storage system or by an administrative node or nodes. Monitoring of individual data objects may be triggered by short-period timers, may run continuously as a background process, and/or may be additionally triggered by various events, including usage of system resources at above threshold levels, detected performance degradation of the multi-node data-storage system, or in response to other events. In alternative embodiments of the present invention, the monitoring routine may additionally monitor operational characteristics of the multi-node data storage system, or may monitor operational characteristics of the multi-node data storage system in order to detect events or characteristics that trigger a next monitoring of individual data objects or groups of data objects.

Many different rules may be associated with data objects, or groups of data objects, that trigger snapshot operations, including:

dataObject.mirror_size( ) > threshold_mirror_size
dataObject.num_write_accesses( ) < threshold_accesses
system.memory_usage( ) > threshold_usage &&
dataObject.mirror_size( ) > threshold

In these rules, numerical values returned by calls to member functions of instances of data-object and system classes are compared to threshold values to determine whether or not to trigger a snapshot operation. Alternatively, these rules can be used as predicates during computation of a snapshot metric, so that, when the predicates evaluate to TRUE, a value is added to a cumulative value that is used as the value of a snapshot metric.

A snapshot operation may be triggered for a data object when the mirrored portion of the data object exceeds an absolute or relative threshold value, when the number of WRITE accesses to the data units stored in the mirrored portion of the data object fall below an absolute or relative value, when computational bandwidth of the data-storage system falls below a threshold bandwidth and the data object falls within a set of largest data objects, when system data-storage capacity falls below a threshold capacity and the data object falls within a set of largest data objects, and for many additional reasons. Snapshot operations may be triggered for individual objects or may be triggered for groups of objects, where grouping are based on node locations, users who created the data objects, administrative groupings based on accessing host computers or stored-data ownership, or other such criteria. An adaptive process may, rather than employing static rules, experimentally carry out snapshot operations and monitor system characteristics following the experimental snapshot operations in order to learn how to optimize various system characteristics, including storage and computational overheads over time by carrying out snapshot operations.

Although the present invention has been described in terms of particular embodiments, it is not intended that the invention be limited to these embodiments. Modifications will be apparent to those skilled in the art. For example, many different implementations of the automated-snapshot-triggering mechanism discussed above used in multi-node data-storage systems that represent embodiments of the present invention can be obtained by varying common implementation parameters, including programming language, control structures, modular organization, data structures, underlying operating system, and other implementation parameters. Many different rules and/or terms that contribute to a snapshot metric may be used, in various embodiments of the present invention, in order to achieve optimization of multi-node-data-storage-system operational characteristics. While a data object is stored in a mirrored portion and a parity-encoded portion, in the above-described embodiments of the present invention, a different type of space-efficient redundant storage other than parity-encoding storage may be used in alternative embodiments of the present invention.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A multi-node data-storage system comprising:
a number of component-data-storage-system nodes that store data objects, each data object stored as a mirrored portion and an additional portion; and
a snapshot-operation-triggering mechanism that invokes a snapshot operation on a data object in which mirrored data stored in the mirrored portion of the data object is transformed into data stored in non-mirroring redundant data storage associated with a next snapshot level within the additional portion of the data object.

2. The multi-node data-storage system of claim 1 wherein the snapshot-operation-triggering mechanism is implemented by computer instructions that execute on one or more nodes of the component-data-storage-system.

3. The multi-node data-storage system of claim 1 wherein the non-mirroring redundant data storage is parity-encoding redundant data storage in which data units that store data and data units that store a computed checksum for the stored data are striped across multiple nodes.

4. The multi-node data-storage system of claim 1 wherein the mirrored portion of a data object is distributed over one of:
a different set of nodes than a set of nodes over which the additional portion of the data object is distributed;
the same set of nodes as the set of nodes over which the additional portion of the data object is distributed; and
a set of nodes that partially overlaps the set of nodes over which the additional portion of the data object is distributed.

5. The multi-node data-storage system of claim 1 wherein data in a first snapshot level associated with a data object is distributed over one of:
a different set of nodes than a set of nodes over which data in a second snapshot associated with a data object is distributed;
the same set of nodes as the set of nodes over which data in a second snapshot associated with a data object is distributed; and
a set of nodes that partially overlaps the set of nodes over which data in a second snapshot associated with a data object is distributed.

6. A multi-node data-storage system comprising:
a number of component-data-storage-system nodes that store data objects, each data object stored as a mirrored portion and an additional portion; and
a snapshot-operation-triggering mechanism that automatically invokes a snapshot operation on a data object in which mirrored data stored in the mirrored portion of the data object is transformed into data redundantly stored in non-mirroring redundant data storage associated with a next snapshot level within the additional portion of the data object.

7. The multi-node data-storage system of claim 6 wherein the snapshot-operation-triggering mechanism is implemented by computer instructions that execute on one or more nodes of the component-data-storage-system.

8. The multi-node data-storage system of claim 6 wherein the snapshot-operation-triggering mechanism periodically operates within the multi-node data-storage system to identify data objects upon which to carry out a snapshot operation.

9. The multi-node data-storage system of claim 6 wherein the automated snapshot-operation-triggering mechanism identifies data objects upon which to carry out a snapshot operation by:
for each data object,
collecting stored data that describes the data object;
based on the collected stored data, evaluating one or more rules; and
when evaluation of a rule indicates that a snapshot operation is to be carried out on the data object, identifying the data object as a data object upon which to carry out a snapshot operation.

10. The multi-node data-storage system of claim 6 wherein the automated snapshot-operation-triggering mechanism identifies data objects upon which to carry out a snapshot operation by:
for each data object,
collecting stored data that describes the data object;
based on the collected stored data, computing a snapshot metric; and
when the computed snapshot metric has a value greater than a threshold value, identifying the data object as a data object upon which to carry out a snapshot operation.

11. The multi-node data-storage system of claim 8 wherein the automated snapshot-operation-triggering mechanism identifies data objects upon which to carry out a snapshot operation based on one or more of:
whether the mirrored portion of the data Object exceeds a threshold size;
whether the data object has been accessed for WRITE operations directed to data units in the mirrored portion of the data object more than a threshold number of times during a preceding time interval;
whether the remaining storage capacity of the multi-node data-storage system has fallen below a threshold capacity; and
whether the computational bandwidth of the multi-node data-storage system has fallen below a threshold bandwidth.

12. The multi-node data-storage system of claim 6 wherein the non-mirroring redundant data storage is parity-encoding redundant data storage in which data units that store data and data units that store a computed checksum for the stored data are striped across multiple nodes.

13. The multi-node data-storage system of claim 6 wherein the mirrored portion of a data object is distributed over one of:
a different set of nodes than a set of nodes over which the additional portion of the data object is distributed;
the same set of nodes as the set of nodes over which the additional portion of the data object is distributed; and
a set of nodes that partially overlaps the set of nodes over which the additional portion of the data object is distributed.

14. The multi-node data-storage system of claim 6 wherein the data in a first snapshot level associated with a data object is distributed over one of
a different set of nodes than a set of nodes over which data in a second snapshot associated with a data object is distributed;
the same set of nodes as the set of nodes over which data in a second snapshot associated with a data object is distributed; and
a set of nodes that partially overlaps the set of nodes over which data in a second snapshot associated with a data object is distributed.

15. A method for efficiently storing data objects in a multi-node data-storage system that includes a number of component-data-storage-system nodes that store data objects, the method comprising:
storing each data object stored as a mirrored portion and an additional portion; and
triggering a snapshot operation on a data object in which mirrored data stored in the mirrored portion of the data object is transformed into data redundantly stored in non-mirroring redundant data storage associated with a next snapshot level within the additional portion of the data object.

16. The method of claim 15 wherein the non-mirroring redundant data storage is parity-encoding redundant data storage in which data units that store data and data units that store a computed checksum for the stored data are striped across multiple nodes.

17. The method of claim 15 wherein a snapshot operation is automatically triggered by an automated snapshot-operation-triggering mechanism implemented by computer instructions that execute on one or more nodes of the component-data-storage-system.

18. The method of claim 17 wherein the snapshot-operation-triggering mechanism periodically operates within the multi-node data-storage system to identify data objects upon which to carry out a snapshot operation.

19. The multi-node data-storage system of claim 17 wherein the automated snapshot-operation-triggering mechanism identifies data objects upon which to carry out a snapshot operation by:
for each data object,
collecting stored data that describes the data object;
based on the collected stored data, evaluating one or more rules; and
when evaluation of a rule indicates that a snapshot operation is to be carried out on the data object, identifying the data object as a data object upon which to carry out a snapshot operation.

20. The multi-node data-storage system of claim 17 wherein the automated snapshot-operation-triggering mechanism identifies data objects upon which to carry out a snapshot operation by:
for each data object,
collecting stored data that describes the data object;
based on the collected stored data, computing a snapshot metric; and
when the computed snapshot metric has a value greater than a threshold value, identifying the data object as a data object upon which to carry out a snapshot operation.
